(19) United States
(12) Patent Application Publication
(10) Pub. No.: US 2022/0198483 A1
(43) Pub. Date: Jun. 23, 2022

(54) AUTOMATED REPLENISHMENT SHOPPING PLATFORM

(71) Applicant: Replenium Inc., Seattle, WA (US)

(72) Inventors: Thomas W. FURPHY, Sammamish, WA (US); William Justin LEIGH, Seattle, WA (US); Umair BASHIR, Issaquah, WA (US)

(21) Appl. No.: 17/126,841

(22) Filed: Dec. 18, 2020

(51) Int. Cl. G06Q 30/02; G06Q 30/06; G06Q 10/08; G06Q 50/04; G06N 20/00

(52) U.S. Cl. CPC G06Q 30/0202; G06Q 30/0633; G06Q 30/0631; G06Q 30/0222; G06Q 30/0239; G06N 20/00; G06Q 10/0838; G06Q 50/04; G06Q 10/0875; G06Q 30/0226; G06Q 30/0223

(57) ABSTRACT

An auto-replenishment platform may receive consumer data, retailer data and product data for a set time period, via an e-commerce platform of a retailer or manufacturer that sells products and services directly to the public. Using the consumer data, the auto-replenishment platform may determine the auto-replenishment product basket for the consumer. Subsequently, the auto-replenishment platform may generate a consumer model for the consumer, based at least on the consumer data, the retailer data, and the manufacturer data, for predicting the consumer auto-replenishment shopping cart, consumer behavior, and determining alternate auto-replenishment products and discounts for the consumer. The auto-replenishment platform may send the consumer model to the e-commerce retailer and suggest auto-replenishment products and discounts to the consumer.

### BACKGROUND

The advent of the Internet has brought revolutionary changes to the way consumers shop for products and services. Prior to the Internet, the purchase of goods and services required a substantial investment of time and energy in researching the desired product or service, investigating into the reputation of the brick and mortar store that supplied the product or service, and going to the brick and mortar store to make the selection and purchase the desired product or service. The Internet radically changed the purchasing process by minimizing the investment of time and energy the consumer needs to expend in the selection and purchase of goods and services. Additionally, there are dozens of websites that rate goods and services, as well as brick and mortar stores, to ease the decision-making process for the consumer.

The onset of online stores, or e-commerce industry, provided additional conveniences to the consumer by saving his/her travel time to the brick and mortar store to make a purchase. While initially, brick and mortar stores provided an e-commerce platform as an additional way to increase sales, online shopping has proved to be the consumer's preferred purchasing method for products and services. To satisfy consumers' demand for convenience, there are now multiple e-commerce-only platforms that can provide almost anything a customer would want. A consumer's effort to buy a product has been reduced to a few clicks on a computer, and the product shows up at the customer's door in a few days.

The auto-replenishment platform is a step in the e-commerce revolution that increases efficiencies for the consumer by allowing the customer to make purchases of consumable items at regular intervals, so that the customer may always have a desired quantity on hand. The auto-replenishment system eliminates the need for the consumer to spend time making weekly and monthly purchases of household consumables, as items regularly bought by the consumer household are refilled automatically without the intervention of the consumer. Additionally, the consumer has the ability to adjust the frequency and volume of the auto-replenishment cart thereby updating the quantities and schedules of auto-replenishment items, as needed.

### BRIEF DESCRIPTION OF THE DRAWINGS

The detailed description is depicted with reference to the accompanying figures, in which the left most digit(s) of a reference number identifies the figure in which the reference number first appears. The use of the same reference numbers in different figures indicates similar or identical items.

FIG. 1 illustrates an example architecture for implementing auto-replenishment method.

FIG. 2 illustrates an example architecture for implementing auto-replenishment engine.

FIG. 3 is a block diagram showing various components of a computing device that implements auto-replenishment method.

FIG. 4 shows an illustrative user interface page displayed on a mobile device of a merchant to inform the customer of the auto-replenishment option for a product and enable the customer to select the auto-replenishment option and adjust the auto-replenishment period.

FIG. 5 is a flow diagram of an example process for the auto-replenishment engine that is implemented by the auto-replenishment platform.

FIG. 6 is a flow diagram of an example process for determining auto-replenishment products from the consumer shopping cart.

### DETAILED DESCRIPTION

This disclosure is directed to techniques for generating a consumer auto-replenishment profile, in real time, that is based on inputs from the consumer, on product information, and on retailer and manufacturer data to develop an auto-replenishment shopping cart for the consumer that may be customized with alternative products and tailored shipping time frames. For the e-commerce platform, for the retailer, and for the manufacturer, the auto-replenishment platform provides another sales channel and a method for connecting with the customer and improving customer satisfaction; however, there is a need for the auto-replenishment system to understand and predict the consumer behavior and improve the shopping experience.

An auto-replenishment platform provides the consumer an option to auto-replenish consumable household items at a frequency recommended by the auto-replenishment platform and that are chosen or confirmed by the consumer. The auto-replenishment platform may be deployed on a retailer's online platform, may be modeled for a specific group of products on a retailer's platform, and/or may be deployed for a specific brand. Additionally, a manufacturer may use the auto-replenishment platform to service the consumer directly.

The auto-replenishment platform may store and analyze the consumer's shopping trends and purchasing data and, with the information, it may develop consumer-specific as well as consumer-aggregated usage models, including behavioral models, that improve the consumer shopping experience and the retailer and manufacturer operations. It provides the retailer and manufacturer with predictions or forecasts of consumer activity, enabling them to plan and manage product inventory, pricing and placement on a more efficient basis. Additionally, as the auto-replenishment platform aggregates and synthesizes data from multiple retailer and manufacturer e-commerce platforms, it is able to customize consumer loyalty programs and consumer shopping incentives.

For the consumer, the auto-replenishment platform results in a lower investment of time and effort in the tasks of shopping for basic household items, prevents the consumer from running out of basic needed items, and provides improved control tools to enable the consumer to easily and efficiently manage replenishment logistics. More specifically, the consumer can effortlessly receive the most regularly used products when needed and in desired quantities.

For retailers and direct-to-consumer manufacturers, the auto-replenishment platform may provide a tool that directly engages the consumer and increases the retailer and manufacturers brand loyalty. Additionally, the platform may provide the retailer and manufacturer with tools to better track consumer behavior and understand and estimate consumer trends. The consumer purchase and frequency data may be aggregated or mined to determine relative consumption of specific items and provide the consumer with alternatives and recommendations of other products. The data can be used to track and predict consumer behavior to improve their shopping experience, by offering the consumer customized shopping incentives and other customized loyalty benefits.

### Illustrative System Architecture

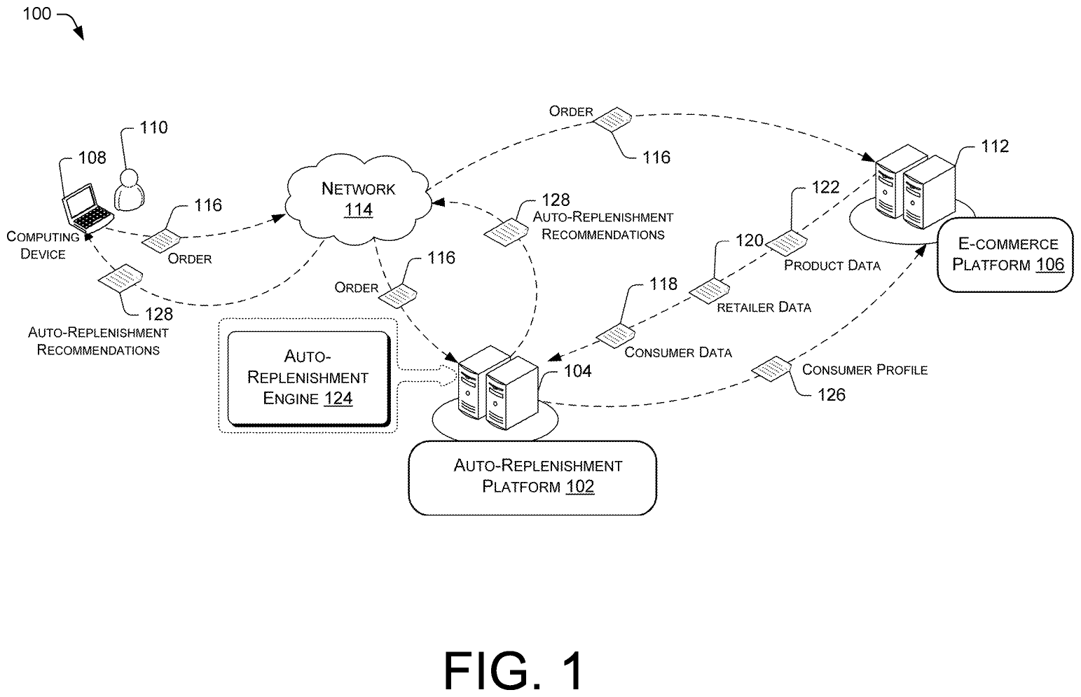

FIG. 1 is a schematic diagram of an illustrative computing environment 100 for using an auto-replenishment platform to support the use of an automated auto-replenishment service on e-commerce platforms for retailers and manufacturers. The computing environment shows an auto-replenishment platform 102 with an auto-replenishment engine 124 that acts as an intermediary between a consumer, such as consumer 110, and a vendor or provider of services, such as e-commerce platform 106. As will be described in greater detail further below, the e-commerce platform 102 and auto-replenishment engine 124 can exchange information with the computing device 108 of the consumer 110 and the e-commerce platform 106, to facilitate commercial transactions between them, such as periodic resupply of goods and services to the consumer.

The servers 104, of the auto-replenishment platform 102, may interact with one or more e-commerce platforms, such as e-commerce platform 106. The e-commerce platform 106 may include an online sales presence of a retailer or service provider, the online sales presence of a manufacturer that provides goods directly to the consumer, or an online sales presence the resells goods of third-party retailers and manufacturers. The servers 104, of the auto-replenishment platform 102, may also interact with one or more computing devices, such as computing device 108 that is used by a customer 110. In various embodiments, the servers 112, of the e-commerce platform 106, may interact with one or more computing devices, such as computing device 108 that is used by customer 110.

In additional embodiments, the servers 104 of the auto-replenishment platform 102 may communicate with the servers 112, of the e-commerce platform 106, and the customer computing device 108 via a network 114. The network 114 may include one or more of a local area network (“LAN”), a larger network such as a wide area network (“WAN”), a mobile telephone network, and/or a collection of networks, or the Internet. The network 114 may be a wired network, a wireless network, or both.

The computing device 108 may be a mobile communication device, a smart phone, a portable computer, a tablet computer, a slate computer, a desktop computer, or any other electronic device that is equipped with network communication components to receive and transmit data, data processing components to process data, and user interface components to receive data from, and present data to, a user. Further, the computing device 108 may include some type of short-range communication ability that is independent of the network 114.

For the purposes of illustration, FIG. 1 illustrates one computing device and one consumer, but the system 100 can support or can be scaled to support multiple users and multiple computing devices, and in example embodiments, a user may have multiple devices that can each interact with the auto-replenishment platform 102 and other components of the system. In some embodiments, each of the computing devices, such as computing device 108, may be equipped with Near Field Communications (NFC) transceivers that enable the devices to directly exchange data. In other embodiments, each of the computing devices may include components that enable the devices to exchange data via a Bluetooth link, a Wi-Fi connection, light-based communication (e.g., infrared data transfer), image-based communication (e.g., quick response (QR) codes), and/or acoustic-based data transfer.

The e-commerce platform 106 may be an online retailer website for a retailer with which the customer 110 has established one or more user accounts. A user account for the customer 110 may include account access information that enables the customer 110 to conduct a sales transaction with the e-commerce platform 106. The account access information may include bank account numbers, routing numbers, security codes, passwords, payment instrument expiration dates, and/or so forth. Additionally, the e-commerce platform 106 may provide the customer 110 the option to select products and services for individual purchase or may provide for repeated purchases at regular time intervals, such as an auto-replenishment platform.

The consumer 110 may initially place an order 116 for one or more products with the e-commerce platform 106. In this case, the order 116 details may be routed to the auto-replenishments platform 102 for processing and analysis. The order data 118 may be received by the auto-replenishment platform 104 when the order 116 is placed by the consumer 110. Alternatively, the order data 118 may be received by the auto-replenishment platform 102 individually for each consumer, or received in an aggregated format for multiple consumers, on a periodic basis.

Additionally, the auto-replenishment platform 102 may receive the retailer data 120 via the e-commerce platform 106. In example embodiments, the retailer data 120 may include a list of products that are sold by the e-commerce platform, the associated retailer pricing for each product, a quantity of each product that the retailer has in stock, the location of the product that is in stock, product weight and dimensions of the product packaging, product shipping information, a manufacturing source for each product and manufacturing lead times, alternative sources for each product, and so forth. The retailer data 120 may be received by the auto-replenishment platform 102 on a periodic basis or as needed due to changes in the retailer data 120.

Furthermore, the auto-replenishment platform 102 may receive product data 122 via the e-commerce platform 106. The product data 122, may include, but is not be limited to, a category and a sub-category for each product, associated manufacturer suggested pricing for each product, a product description, a characterization of the product performance, and any other information that qualifies and categorizes each product.

In another embodiment, the consumer 110 may place an order 116, with the auto-replenishment engine 102, for the auto-replenishment of at least one product. The order 116 may contain one or more specific products selected by the customer 110 for purchase, a quantity of each product that is included on the auto-replenishment order list, a time period for auto-replenishment, a shipping address of where the products are to be delivered, and a method of payment for the products. The time period for auto-replenishment may include an interval of time between the shipments of auto-replenishment products.

Subsequently, the auto-replenishment engine 124 may be implemented by the computing devices 104 of the auto-replenishment platform 102. The auto-replenishment engine 124 may generate a consumer profile 126 that may be confined to the consumer data 118, the retailer data 120, and the product data 122. The consumer profile 126 may include, as examples, auto-replenishment product suggestions for the consumer, consumer discounts and shopping incentives, and consumer shopping trends and consumer behavior data. The consumer profile 126 may be transmitted to the e-commerce platform 106 of the retailer or the manufacturer that services the consumer directly. Based on the consumer profile 126, the retailer and manufacturer may predict the consumer activity, and thereby plan product inventory and customize consumer loyalty programs and shopping incentives.

Based on the consumer profile 126, the auto-replenishment platform 102 may form auto-replenishment recommendations 128 for the consumer. The auto-replenishment recommendations 128 may include suggestions to the consumer for auto-replenishment products, an associated suggested auto-replenishment product volume, an associated suggested auto-replenishment delivery interval time period, and any consumer discounts and incentives. The selection of the suggested auto-replenishment products, the delivery interval time period for auto-replenishment, and other shopping incentives and discounts may be generated by the auto-replenishment platform 102 and forwarded directly to the consumer via the auto-replenishment platform 102, or via the e-commerce platform 106. The selection of auto-replenishment products, discounts and incentives, and the adjustment of the auto-replenishment delivery interval time period may be adjusted, accordingly, by the consumer 110.

### Illustrative Engine Architecture

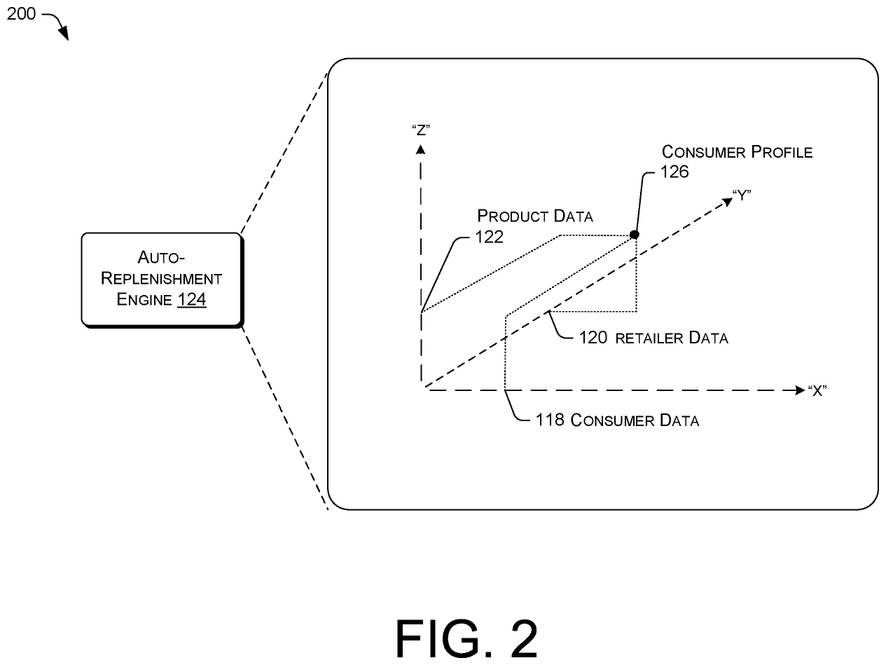

FIG. 2 is a diagram consistent with an example process or structure by which the auto-replenishment engine 124 may develop the consumer profile 126. FIG. 2 shows the consumer profile 126 as a 3-dimensional array, defined by the “x”, “y” axes in the horizontal plane and “z” axis in the vertical plane. In some embodiments, the “x” axis may be constrained to, or represent, the consumer data 118, while the “y” axis is defined by, or represents, the retailer data 120. In some embodiments, the consumer data 118 presented along the “x” axis, may include an enumeration of products the consumer 110 has purchased or placed in an on-line shopping cart. In additional embodiments, the consumer data 118, shown on the “x” axis, may include any other data that qualifies the consumer's shopping history of products, services and auto-replenishment products. The retailer data, 120 presented along the “y” axis, may include an enumeration of the products the e-commerce platform is offered by the retailer or manufacturer to the consumer. In additional embodiments, the information included in the retailer data on the “y” axis may contain product sales volumes, product stock volumes, or any other data that qualifies the retailer data of the e-commerce platform.

The vertical axis “z” may be constrained to, or represent, the product data 122. The product data 122 enumerated on the “z” axis may include information that qualifies the products provided by the e-commerce platform to the consumer. The product qualifying information may include product pricing, product use, product description, or any other data that qualifies as the product data of the products that the e-commerce platform provides the consumer.

Subsequently, the auto-replenishment engine 124, via a decision tree algorithm and the aggregation of data that is constrained by the “x”, “y” and “z” axes, may generate the consumer profile 126 that is specific to the consumer. In additional embodiments, the consumer profile 126 may embody a composite consumer profile that represents a group of consumers or a demographic of consumers.

### Example Server Components

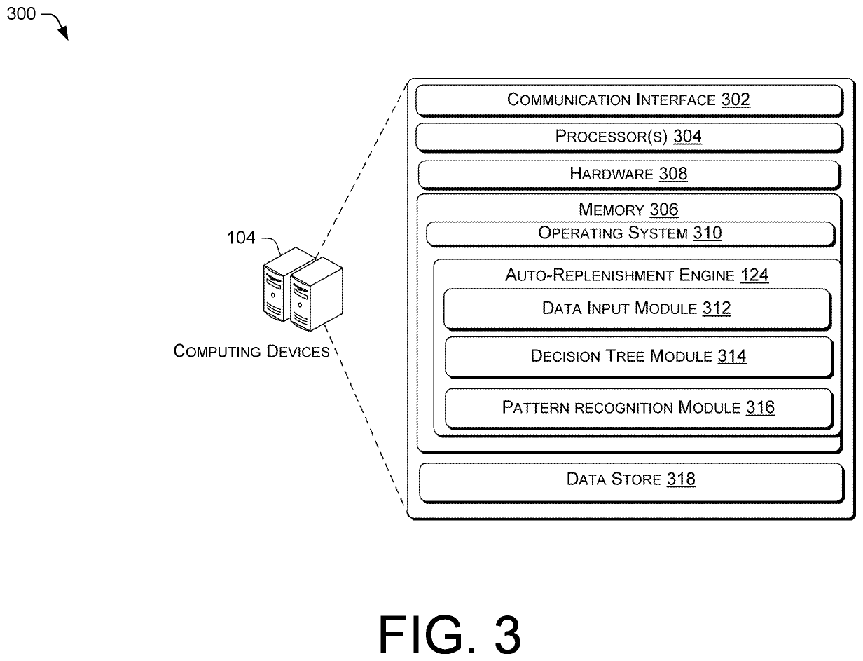

FIG. 3 is a block diagram showing various components of the auto-replenishment platform 102 that implements the auto-replenishment engine 124. The auto-replenishment engine 124 may be implemented on one or more computing devices 104 that are part of the auto-replenishment platform 104. The computing devices 104 may include general purpose computers, such as desktop computers, tablet computers, laptop computers, servers, or other electronic devices that are capable of receiving inputs, processing the inputs, and generating output data. In other embodiments, the computing devices 104 may be virtual computing devices in the form of virtual machines or software containers that are hosted in a cloud. The computing devices 104 may be equipped with a communication interface 302, one or more processors 304, memory 306, and device hardware 308. The communication interface 302 may include wireless and/or wired communication components that enable the computing devices to transmit data to and receive data from other networked devices via a communication network. The device hardware 308 may include additional hardware that performs user interface, data display, data communication, data storage, and/or other server functions.

The memory 306 may be implemented using computer-readable media, such as computer storage media. Computer-readable media includes at least two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, Random-Access Memory (RAM), Dynamic Random-Access Memory (DRAM), Read-Only Memory (ROM), Electrically Erasable Programable Read-Only Memory (EEPROM), flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. Computer readable storage media do not consist of, and are not formed exclusively by, modulated data signals, such as a carrier wave. In contrast, communication media may embody computer-readable instructions, data structures, program modules, or other data in a modulated data signal, such as a carrier wave, or other transmission mechanism.

The processors 304 and the memory 306 of the computing devices 104 may implement an operating system 310 and the auto-replenishment engine 124. The operating system 310 may include components that enable the computing devices 104 to receive and transmit data via various interfaces (e.g., user controls, communication interface, and/or memory input/output devices), as well as process data using the processors 304 to generate output. The operating system 310 may include a display component that presents the output (e.g., display the data on an electronic display, store the data in memory, transmit the data to another electronic device, etc.). Additionally, the operating system 310 may include other components that perform various additional functions generally associated with an operating system.

The auto-replenishment engine 124 may include a data input module 312, a decision tree module 314, and a pattern recognition module 316. The auto-replenishment engine 124 may also interact with a data store 318. These modules may include routines, program instructions, objects, and/or data structures that perform particular tasks or implement particular abstract data types.

The data input module 312 may receive consumer data sets 118, retailer data sets 120, and product data sets 122 via the network 114. The consumer data sets 118 may include the products purchased by the consumer or the products that are in the consumer shopping cart. Example consumer data sets 118 may include a list of products the consumer ordered from the e-commerce platform for a set time period, such as a month. Additionally, this may include a list of products the consumer ordered repeatedly for the set time period through the e-commerce platform or via the auto-replenishment platform of the e-commerce retailer. The retailer data sets 120 may include products the e-commerce platform shows as being for sale by the retailer or manufacturer and available to the consumer for purchase. Example retailer data sets 120 may include a list of products held in stock or warehoused and sold via the e-commerce platform and may be categorized according to product use, associated retailer product pricing, product stock volume, or any product categorization and sub categorization used by retailers and manufacturers. The product data sets 122 may include suggested manufacturer product pricing, product use, product description, or any other data that qualifies as the product data that the e-commerce platform provides to the consumer.

The decision tree module 314 may use machine learning algorithms to generate a consumer profile, such as the consumer profile 126. Various classification schemes (explicitly and/or implicitly trained) and/or systems may be employed by the decision tree module 314 for the generation of the consumer profile, such as a probabilistic and/or a statistical based analysis. Other directed and undirected model classification approaches include, e.g., naïve Bayes, Bayesian networks, decision trees, neural networks, fuzzy logic models, and probabilistic classification models providing different patterns of independence may also be employed.

In an example embodiment, the decision tree module 314 may apply a decision tree algorithm to the consumer data sets 118, the retailer data sets 120, and the product data sets 122 to identify critical features of one or more conditions that lead to the consumer profile 126. While an e-commerce platform, such as e-commerce platform 106, may provide multiple data sets (retailer data and product data sets) to the auto-replenishment platform, a single data set may be ineffective in determining a consumer profile. For example, a retailer data set for an e-commerce platform may not be enough to determine a complete shopping profile for the consumer, as it may not provide enough information to develop a complete consumer profile. A consumer profile that is solely based on the retailer data does not include any consumer demand information, so it may not accurately predict the demand side of the product. Similarly, a consumer profile that is solely based on the consumer data does not include retailer information, and so it may not accurately predict the retailer's ability to supply the product to the market. Thus, the aggregation of data from multiple data sets may be a condition to determine the shopping profile for a consumer in real time. For example, the consumer shopping history, the retailer data, and product data points may improve the ability of the auto-replenishment engine 124 to determine the consumer profile in real time.

Accordingly, the decision tree module 314 uses data from the consumer, retailer, and product data sets as the input to decision tree learning in order to develop the consumer profile in real time from an output decision tree. Starting from the consumer, retailer, and product data sets for a consumer, such as consumer 110, a decision tree learning algorithm may find a first data point for the consumer profile, as a corresponding first-time value. The decision tree module may define this as a first data point for establishing the consumer profile in real time. From the updated consumer, retailer, and product data sets, the decision tree algorithm may find a second data point for the consumer profile and a corresponding second time value, which may define a second data point for the consumer profile in real time. The relationship between a first data point and a second data point creates a tree leaf in the decision tree. The update in the consumer, retailer and product data sets provided to the auto-replenishment engine 126, and subsequent change in the relationship between data sets, may create new leaf nodes for the decision tree and updates to the consumer profile 126.

Subsequently, the pattern recognition module 316 may extract/group decision tree leaves based on relationships among or between the data points. The analysis of decision tree leaves of the decision tree may determine a model for the consumer profile 126 in real time. The pattern recognition module 316 may recognize and indicate the consumer behavior that can be used to establish the relative consumer profile 126 for a set time period. Based on the output of the decision tree module 314, decision tree leaves may be grouped by specific data points, as established by the pattern recognition module 316. For example, the pattern recognition module 316, from an enumeration of identical tree leaves for a specified period of time, for a brand or type of consumable product, may determine that the consumer has an auto-replenishment preference for a specific brand consumable product, at a specific price range, with a specific replenishment time period. The grouping of tree leaves by data points, over time, may form a pattern of the relative shopping trends and preferences for the consumer. The pattern of the relative shopping trends and preferences for the consumer may provide the basis for the auto-replenishment recommendations 128. For example, based on the data, the auto-replenishment engine 124 determines the types of products that the consumer has a preference for, and a complementary basket of products may then become the auto-replenishment recommendations 128. The consumer shopping trends and preferences may be revised and updated, as the tree leaves of the decision tree change.

The data store module 318 may store data that are processes or are generated by the auto-replenishment engine 124. The data store module 318 may include one or more databases, such as relational databases, object databases, object-relational databases, and/or key-value databases. In various embodiments, the data store module 318 may include the consumer data 118, the retailer data 120, the product data 122, the consumer profile 126, the auto-replenishment recommendations, and/or other data.

### Example User Interface

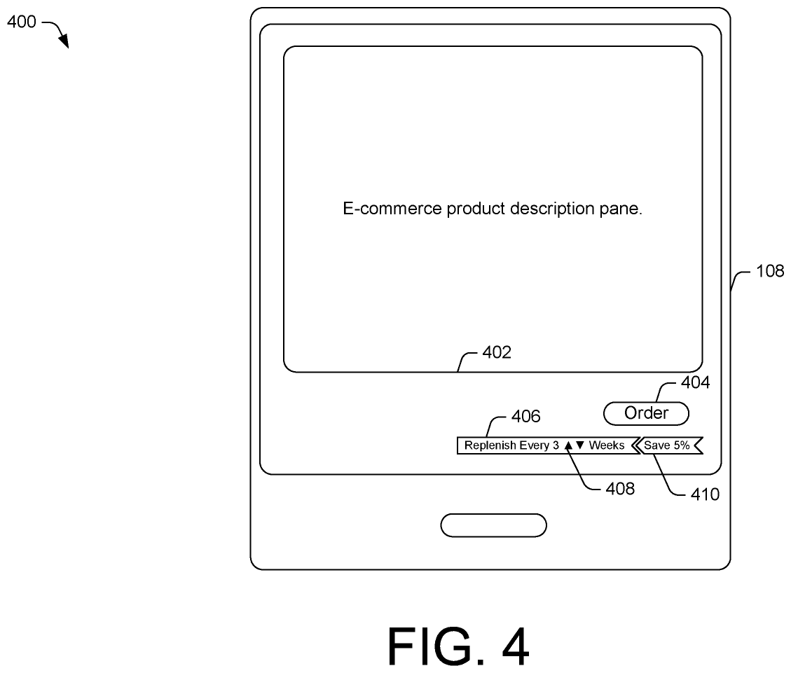

FIG. 4 shows an illustrative user interface page displayed on the computing device 108 of the consumer 110 that may provide the consumer the option of auto-replenishment, for a product that is sold by the retailer or manufacturer via the e-commerce platform. The computing device 108 may be a mobile communication device, a smart phone, a portable computer, a tablet computer, a slate computer, or any other electronic device that is equipped with network communication components to receive and transmit data, data processing components to process data, and user interface components to receive data from and present data to a user.

The user interface pages may be displayed by the e-commerce platform 106 on the computing device 108, such as user interface page 400 when a selection for a transaction or order is pending from a consumer. Additionally, the auto-replenishment platform 102 may forward the consumer discounts and incentives via the user interface of the e-commerce platform 106.

In at least one embodiment, user interface page 400 may include a user device 108, product description field 402 that displays a product or service for purchase, as well as an order button field 404, an auto-replenishment field 406, an auto-replenishment time adjusting field 408, and a promotion identifier field 410. The product description field 402 may provide information on the product that the consumer is offered for purchase by the e-commerce platform 106. For example, the product information many include one or more pictures of the product, the product specifications, quantity of product ordered, product delivery options, and so forth. The order button field 404 may be selected by the consumer and may be received by the e-commerce platform 106 or the auto-replenishment platform 102, for the purchase of the product or service displayed in the product description field 402. The auto-replenishment field 406 may indicate the product or service time period interval for auto-replenishment, while the e-commerce platform 106 or the auto-replenishment platform 102 may receive a request from the consumer to increase or decrease the proposed auto-replenishment time period interval via the auto-replenishment time adjusting field 408. The promotion identifier 410, that may be based on the consumer profile 126, and populated by the auto-replenishment platform 102, may provide the amount of discount or shopping incentive that is applied to the order of the product or service via the auto-replenishment platform.

### Illustrative Operations

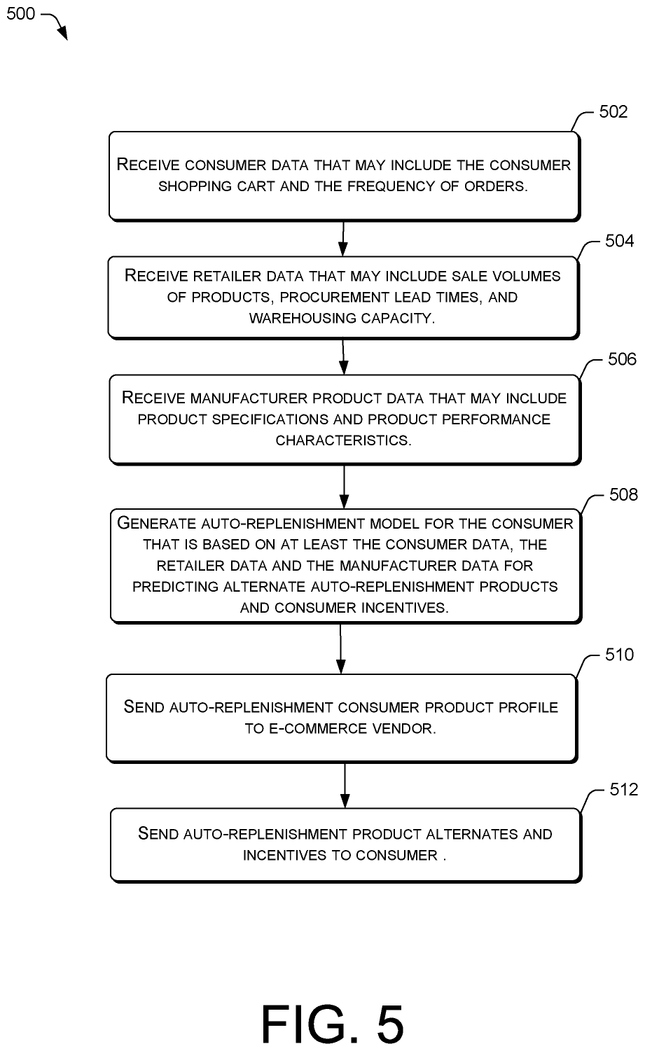

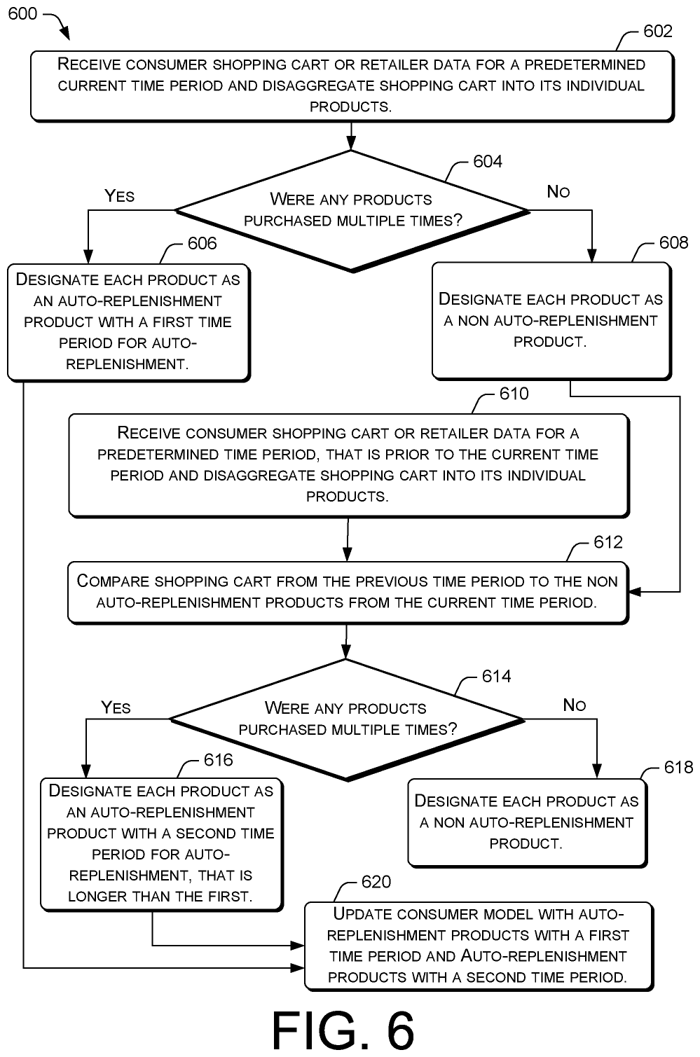

FIGS. 5-6 presents illustrative processes 500-600 for implementing the automated replenishment shopping platform. Each of the processes 500-600 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like, that perform functions or implement abstract data types. The order in which the operations are described is not intended to be construed as a limitation, and any number of the described blocks can be combined in any order and/or in parallel to implement the process. For discussion purposes, the processes 500-600 are described with reference to auto-replenishment environment 100 of FIG. 1.

FIG. 5 is a flow diagram of an example process for implementing the auto-replenishment process via an e-commerce platform. At block 502, an auto-replenishment platform receives, via an e-commerce platform or a consumer order, an order for a product or service or a shopping cart of products or services. The order or shopping cart may include a time period for auto-replenishment.

At block 504, the auto-replenishment platform receives, via the e-commerce platform, a retailer's or a manufacturer's data. The data may include, but is not limited to, a list of products or services offered by the retailer or manufacturer via the e-commerce platform, information on the volume of product stock, product shipping information, product lead times and product warehousing capacity.

At block 506, the auto-replenishment platform may receive, via the e-commerce platform, the retailer or manufacturer product data. This data may include, but is not limited to, pricing for products and services, categorization of products and services, performance specifications and characteristics of products, and descriptions or key words that describe products and services offered by the retailer or manufacturer via the e-commerce platform.

At block 508, the auto-replenishment engine 124 may generate a consumer profile 126 based on the consumer data 118, the retailer data 120, and the product data 122. In various embodiments, the consumer profile 126 may be generated using a machine learning algorithm that uses the consumer data 118, the retailer data 120, and the product data 122, as the boundary locations of the 3-dimensional array. The consumer profile 126 may contain predictions for consumer behavior and suggested alternates for auto-replenishment products and services and discounts to the consumer.

At block 510, the auto-replenishment platform may send the consumer profile 126 to the retailer or manufacturer via the e-commerce platform.

At block 512, based on the consumer profile 126, the auto-replenishment platform may send auto-replenishment recommendations 128 to the consumer.

FIG. 6 is a flow diagram of an example process 600 for defining the auto-replenishment products from the consumer order 116 or the consumer shopping cart. At block 602, the auto-replenishment engine 124 may receive the consumer order 116, the consumer shopping cart, or the consumer data 118 for a predetermined time period. For example, the auto-replenishment engine 124 may receive all product orders placed by the consumer via the e-commerce platform of a retailer or manufacturer. The auto-replenishment engine may enumerate the products and quantity ordered for the predetermined time period. From block 602, the process proceeds to block 604 where a determination is made as to whether identical products were purchased multiple times over the set time period.

If at block 604 the determination was Yes, the process proceeds from block 604 to block 606, where the auto-replenishment engine defines the identical products that were purchased more than once over the set time period as auto-replenishment products with a time period as a first time period. From block 606, the process proceeds to block 620, where the auto-replenishment engine may update the consumer model with the auto-replenishment products with a first set time period.

If at block 604 the determination was No, then the process proceeds from block 604 to block 608, where the auto-replenishment engine defines the products that were not purchased more than once over the set time period as non-auto-replenishment products. From block 608, the process proceeds to block 612. In block 610, the auto-replenishment engine receives the consumer order 116, or consumer data 118 for the consumer for a set period of time that is prior to the current time period, and then that part of the process proceeds to block 612. In block 612, results of blocks 608 and 610 are used to compare the non-auto-replenishment products from the current period with the consumer orders, shopping cart or consumer data of the consumer from the prior set time period.

From block 612, the process proceeds to decision block 614, where a determination is made as to whether identical products were included in the inventory of non-auto-replenishment products of the current set time period, and the orders or shopping cart of the consumer from the prior set time period. If the determination is No, then the process proceeds from block 614 to block 618, where the auto-replenishment engine defines the products that are not identical on both, the non-auto-replenishment product inventory and the orders or shopping cart of the consumer from the previous set time period, as non-auto-replenishment products. If the determination is Yes, then the process proceeds to block 616, where the auto-replenishment engine defines the products that are identical on both, the non-auto-replenishment product inventory and the orders or shopping cart of the consumer from the previous set time period, as auto-replenishment products with a second time period, that is longer than the first time period. From block 616, the process proceeds to block 620, where the results of blocks 616 and 606 are used to update the consumer model with the auto-replenishment products, from block 606, with a first time period and with the auto-replenishment products, from block 616, with a second time period.

In accordance with example embodiments, the process steps in FIG. 6 can be repeated, for example in the sequences shown.

### CONCLUSION

Although the subject matter has been described in language specific to the structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more non-transitory computer readable media storing computer-executable instructions that, when executed, cause one or more processors to perform acts comprising:
receiving consumer data for a consumer shopping cart for a set time period from an e-commerce merchant;
receiving retailer data for the e-commerce merchant for the set time period;
receiving product data for the e-commerce merchant for the set time period;
determining a consumer auto-replenishment basket for the consumer shopping cart, for the set time period;
generating a consumer profile for the consumer, based at least on the consumer data, the retailer data, and the manufacturer data, the consumer model for predicting the consumer auto-replenishment shopping cart, consumer behavior, and providing alternate auto-replenishment products and discounts; and
updating and sending the consumer profile to the e-commerce retailer and sending alternate auto-replenishment product suggestions and discounts to the consumer.

2. The one or more non-transitory computer readable media of claim 1, wherein the consumer data is an inventory of the consumer purchased goods and services, wherein the inventory includes a list of goods, a quantity of goods and services purchased, and associated pricing paid for the goods and services.

3. The one or more non-transitory computer readable media of claim 1, wherein the retailer data is an inventory of the goods and services provided, stock volume, product shipping information, and manufacturing and shipping lead times.

4. The one or more non-transitory computer readable media of claim 1, wherein the product data is a description of products and services that includes pricing, use, description, specifications and performance characteristics.

5. The one or more non-transitory computer readable media of claim 1, wherein the auto-replenishment suggestions are based on the consumer profile established for a set time period, wherein the auto-replenishment suggestions are routed to the consumer.

6. The one or more non-transitory computer readable media of claim 5, wherein the consumer auto-replenishment basket is determined based on the consumer shopping basket established for a time period that is immediately preceding the set time period, wherein auto-replenishment products are identical products the consumer purchases on more than one occasion during the immediately preceding time period and the set time period.

7. The one or more non-transitory computer readable media of claim 1, wherein the acts further comprise:
receiving updates to at least one of the consumer data, the retailer data, or the manufacturer data; and
generating an updated consumer profile that is based on the at least one of the updated consumer data, retailer data or manufacturer data.

8. A system, comprising:
one or more processors; and
memory having instructions stored therein, the instructions, when executed by the one or more processors, cause the one or more processors to perform acts comprising:
receiving consumer data for a consumer shopping cart for a set time period from an e-commerce merchant;
receiving retailer data for the e-commerce merchant for the set time period;
receiving product data for the e-commerce merchant for the set time period;
determining the consumer auto-replenishment basket for the consumer shopping cart, for the set time period;
generating a consumer profile for the consumer, based at least on the consumer data, the retailer data, and the manufacturer data, the consumer model for predicting the consumer auto-replenishment shopping cart, consumer behavior, and providing alternate auto-replenishment products and discounts; and
updating and sending the consumer profile to the e-commerce retailer and sending alternate auto-replenishment product suggestions and discounts to the consumer.

9. The system of claim 8, wherein the consumer data is an inventory of the consumer purchased goods and services, wherein the inventory includes a list of goods, a quantity of goods and services purchased, and associated pricing paid for the goods and services.

10. The system of claim 8, wherein the retailer data is an inventory of the goods and services provided, stock volume, product shipping information, and manufacturing and shipping lead times.

11. The system of claim 8, wherein the product data is a description of products and services that includes pricing, use, description, specifications and performance characteristics.

12. The system of claim 8, wherein the auto-replenishment suggestions are based on the consumer profile established for a set time period, wherein the auto-replenishment suggestions are routed to the consumer.

13. The system of claim 12, wherein the consumer auto-replenishment basket is determined based on the consumer shopping basket established for a time period that is immediately preceding the set time period, wherein auto-replenishment products are identical products the consumer purchases on more than one occasion during the immediately preceding time period and the set time period.

14. The system of claim 8, wherein the acts further comprise:
receiving updates to at least one of the consumer data, the retailer data, or the manufacturer data; and
generating an updated consumer profile that is based on the at least one of the consumer data, the retailer data or the manufacturer data.

15. A computer implemented method, comprising:
receiving consumer data for a consumer shopping cart for a set time period from an e-commerce merchant;
receiving retailer data for the e-commerce merchant for the set time period;
receiving product data for the e-commerce merchant for the set time period;
determining the consumer auto-replenishment basket for the consumer shopping cart, for the set time period;
generating a consumer profile for the consumer, based at least on the consumer data, the retailer data, and the manufacturer data, the consumer model for predicting the consumer auto-replenishment shopping cart, consumer behavior, and providing alternate auto-replenishment products and discounts; and
updating and sending the consumer profile to the e-commerce retailer and sending alternate auto-replenishment product suggestions and discounts to the consumer.

16. The computer implemented method of claim 15, wherein the consumer data is an inventory of the consumer purchased goods and services, wherein the inventory includes a list of goods, a quantity of goods and services purchased, and associated pricing paid for the goods and services.

17. The computer implemented method of claim 15, wherein the retailer data is an inventory of the goods and services provided, stock volume, product shipping information, and manufacturing and shipping lead times.

18. The computer implemented method of claim 15, wherein the product data is a description of products and services that includes pricing, use, description, specifications and performance characteristics.

19. The computer implemented method of claim 15, wherein the auto-replenishment suggestions are based on the consumer profile established for a set time period, wherein the auto-replenishment suggestions are routed to the consumer.

20. The computer implemented method of claim 19, wherein the determination of the consumer auto-replenishment basket is further comprised of the consumer shopping basket established for a time period that is immediately preceding the set time period, wherein auto-replenishment products are identical products the consumer purchases on more than one occasion during the immediately preceding time period and the set time period.
